(19) United States
(12) Patent Application Publication
(10) Pub. No.: US 2026/0367724 A1
(43) Pub. Date: Nov. 19, 2026

(54) Transparent, Touch-Sensitive Operating Element Having Projected Operating Symbols

(71) Applicant: Bayerische Motoren Werke Aktiengesellschaft, Muenchen (DE)

(72) Inventor: Matthias LINDNER, Graefelfing (DE)

(21) Appl. No.: 19/137,701

(22) PCT Filed: Jan. 8, 2025
(86) PCT No.: PCT/DE2025/100010

§ 371 Date: Jun. 11, 2025

(30) Foreign Application Priority Data
Jan. 11, 2024 (DE) 10 2024 100 772.9

(51) Int. Cl. G06F 3/041; B60K 35/10; B60K 35/22; B60K 35/65

(52) U.S. Cl. CPC G06F 3/041; B60K 35/10; B60K 35/22; B60K 35/654; B60K 2360/11; B60K 2360/1438; B60K 2360/20

(57) ABSTRACT

A transparent operating element, in particular for installation in a vehicle, includes: an amorphous transparent body having multiple lateral surfaces arranged at angles in relation to one another, which each, individually or in groups, form a user-side front side, a rear side, and an edge side of the body; and a symbol generating device, which is arranged on an edge-side lateral surface and is designed to generate at least one operating symbol luminescent inward into the body. The rear side is designed to reflect the light originating from the at least one operating symbol inside the body to the front side, which is designed to decouple the light out of the body in the direction of the user, so that each operating symbol appears to the user as a virtual projection. The front side is made essentially transparent and touch-sensitive such that each projected operating symbol is deliberately operable by touching its position in the front side.

### BACKGROUND AND SUMMARY

The invention relates to an operating element operable by touch, which is suitable in particular for installation in a vehicle. The vehicle can be a motor vehicle or any other land vehicle, aircraft, or watercraft. The invention is also directed to an associated production method and to a vehicle equipped with this operating element.

Crystal glass, which is known due to its brilliance, has only been used in vehicles up to this point as a decorative material or cover, for example, as a button cap, or as a lever or feeder for rotational actuators. From a technical viewpoint, the crystal glass thus has no functionality in this case which goes beyond its mechanical strength and optical transparency. Other amorphous transparent bodies made of glass or plastic are generally only placed on an already existing operating element in the production of operating elements. All technical functions required for the operation have to be implemented here by additional elements such as sensor films, optical fibers, and lacquers in the operating element itself, which is covered by the transparent body.

It is the object of the present invention to provide an alternative and/or improved design concept for an operating element, in particular for use in a vehicle.

This object is achieved by a transparent operating element and by a method for its production, as well as a vehicle equipped with this operating element, according to the independent claim(s). Further embodiments are specified in the dependent claims. All refining features and effects mentioned in the claims and the following description for the operating element also apply with respect to its production method and the vehicle, and vice versa in each case.

According to a first aspect, a transparent operating element is provided, which can be designed in particular for installation in a vehicle. The vehicle can be a motor vehicle, but also any other land vehicle, aircraft, or watercraft.

The operating element comprises an amorphous transparent body having multiple lateral surfaces arranged angled in relation to one another, each of which individually or in groups forms a user-side front side, a rear side facing away from the user, and an end side of the body connecting the front side to the rear side. A symbol generating device is arranged (or fastened) on at least one of the lateral surfaces which form the edge side of the body, and is designed to generate an operating symbol illuminating into the interior of the body in this/these lateral surface(s).

In this case, the transparent rear side of the body is designed to reflect the light originating from the at least one operating symbol as much as possible without loss within the body toward the front side, for example, by internal total reflection and/or by way of a reflective coating transparent to the user (for example, in the form of an extremely thin metal layer, etc.). The front side is designed to decouple this light from the body in the direction of the user here, so that each operating symbol is displayed to him/her by its virtual projection having a corresponding predetermined position in the front side.

The front side is also essentially transparent and is designed here as touch-sensitive such that each operating symbol projected in this manner is deliberately operable by touching its mentioned position in the front side. If multiple different operating symbols are provided for activating associated different functions (for example “+” to cause a change to the next higher radio transmitter frequency, “−” to cause a change to the next lower radio transmitter frequency, “OK” to confirm another input, and much more, cf. FIG. 2), they can be tapped individually, i.e. independently of one another and thus selected or activated.

The body can be manufactured, for example, from a colorless or lightly colored glass or plastic which is largely transparent to the light originating from the operating symbols, in particular also from crystal glass. All, at least one, or some of the mentioned lateral surfaces of the body can (but do not necessarily have to) be formed planar.

One concept in the operating element presented herein is thus to reflect illuminated or luminescent operating symbols in a specially formed body, for example, a crystal glass. The operation of the associated functions by touching the front side of the body at the point of the reflected symbols is electrically detectable here by the touch sensitivity of the front side, which can have a special selective coating for this purpose, and can be passed on, for example, by laser-structured conductor tracks on the 3D surface of the body to a corresponding evaluation electronics unit.

A functionally transparent body results, which gives off the effect of a “magic technology” due to its complete transparency (because its front side and rear side are also transparent) in combination with virtual operating symbols reflected via the rear side, and thus can provide a significant contribution to a calming interior having “mysterious” concealed light sources and evaluation electronics. Such operating elements can be manufactured from high-quality materials, which can additionally underline their magic effect. All operating elements, in the case of which the depth of the projection plane can be “concealed” well in this manner, for example, in the steering wheel or in the center console, are suitable as the area of application.

According to one embodiment, the front side of the body is composed in a faceted manner from multiple lateral surfaces arranged at angles in relation to one another. The adjacent lateral surfaces directly adjoin one another here and merge continuously into one another while forming a facet edge that is haptically (and possibly also visually) perceptible by the user. These facet edges can contribute, for example, to the haptic orientation in the front side of the body during the intended use of the operating element. At least two of the projected operating symbols (or their positions in the front side) can be located here on different sides of such a facet edge.

According to one embodiment, the symbol generating device comprises one or more light sources and a light mask illuminated thereby on the at least one lateral surface, in which the luminescent operating symbols are generated. The light mask, which is otherwise opaque, has openings in the form of the operating symbols to be generated, so that light from the light sources penetrates through these openings into the interior of the body and thus generates the luminescent operating symbols in the mentioned lateral surface.

The symbol generating device can be housed in particular in a housing, which is likewise opaque, for example, fastened on the mentioned lateral surface. In addition, the evaluation electronics unit mentioned herein can also be located in this housing. The light sources can be designed arbitrarily in principle. For example, LEDs (light-emitting diodes), which can generate white light or also single-color or multicolored light, are suitable for reasons of space and saving energy. The light mask made of a light-absorbing or light-reflecting material can be vapor deposited, applied, adhesively bonded, or formed in another way on the mentioned lateral surface, for example, as a layer or film.

The front side can in particular be made touch-sensitive in that it comprises at least one electrically conductive layer or coating, which is largely transparent from the viewpoint of the user and is structured depending on location, and which comprises structures and conductor tracks formed according to the mentioned position of each individual projected operating symbol, which lead to an associated evaluation electronics unit. At least a part of this evaluation electronics unit, which triggers the desired function of the respective operating symbol upon being touched by the user, can be formed, for example, on the same lateral surface on which the symbol generating device is also arranged. The evaluation electronics unit can in particular also be housed in a common housing with the symbol generating device.

According to an exemplary embodiment, the transparent operating element presented herein is designed as a component of a shifter module on a steering wheel or on a steering column of a vehicle. In these exemplary applications, the transparent operating element can be/become fastened with its edge side, in particular in the area of its lateral surfaces, on which the symbol generating device is arranged, on the steering wheel or on the steering column or on a shifter module formed thereon, such that the remainder of the transparent body having the projected operating symbols hangs in the air directly in the field of view of the driver. Its above advantages (“magic technology”) can thus be applied particularly well. Upon attachment to a steering wheel, the projected operating symbols represent steering wheel buttons.

According to a further aspect, a method for producing the operating element presented herein is provided. The method comprises providing the above amorphous transparent body, forming, arranging, or fastening the above symbol generating device on at least one of its edge-side lateral surfaces, and forming an essentially transparent touch-sensitive layer or coating in or on the mentioned front side of the body, so that each projected operating symbol is deliberately operable by touching it in the front side.

According to one embodiment, during the production of the touch-sensitive coating, the front side of the body is coated using an electrically conductive material (in particular metal) having a constant layer thickness, in the case of which the material remains essentially transparent from the viewpoint of the user, whereupon this conductive layer is structured at suitable points to create the mentioned touch sensitivity by location-dependent removal of this material (for example by means of a laser). A transparent circuit board thus results. Depending on which technology (for example, resistive, capacitive, etc.) is used, and in which specific embodiment, to produce the touch sensitivity, one, two, or more conductive layers lying one on top of another (with dielectric materials located in between) can be produced. The coating can be carried out here, inter alia, by vapor deposition or PVD (physical vapor deposition).

Alternatively to this embodiment, the respective conductive layer can also immediately be produced having the mentioned structure, which supplies its touch sensitivity functionality. Different coating technologies, inter alia also PVD, can also be used for this purpose.

According to a further aspect, the above vehicle, in particular a motor vehicle, is provided. The vehicle comprises a passenger compartment in which one or more transparent operating elements of the type presented herein are installed.

The above aspects of the invention and their embodiments and specific designs will be explained in more detail hereinafter on the basis of examples shown in the appended drawings. The drawings are used in general solely as schematic illustrations of the fundamental design and functional principle. They can, but do not have to be, understood as an illustration to scale of an exemplary specific design.

### BRIEF DESCRIPTION OF THE DRAWINGS

FIG. 1 is a cross-sectional view of a transparent operating element according to an exemplary embodiment of the invention; and

FIG. 2 is a perspective view of a transparent operating element according to a further exemplary embodiment of the invention from the perspective of its user.

### DETAILED DESCRIPTION OF THE DRAWINGS

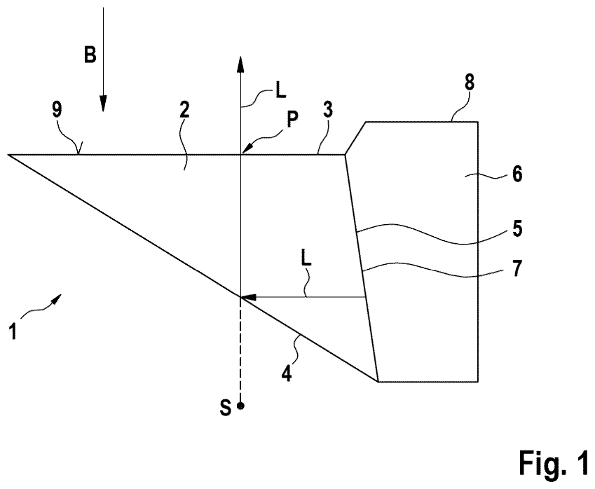

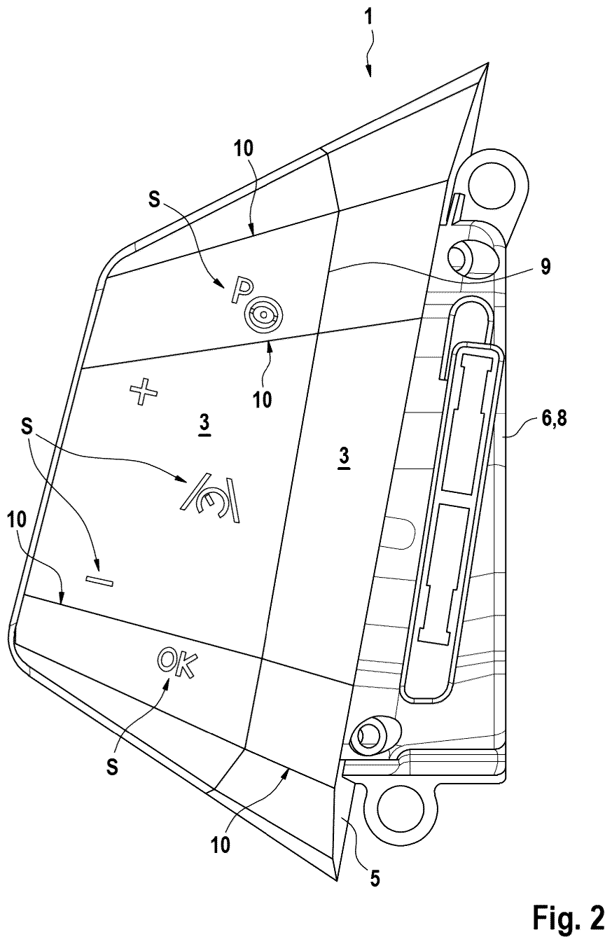

All of the different embodiments, variants, and specific design features of the transparent operating element, the method for its production, and the vehicle according to the above aspects of the invention which are mentioned above in the description and in the following claims can be implemented in the examples shown in FIGS. 1 and 2, in particular also alternatively or additionally to the features shown therein. They are therefore not all repeated once again hereinafter. This also applies correspondingly to the reference definitions and effects already indicated above with respect to individual features, which are shown in FIGS. 1-2.

FIG. 1 shows a very simplified schematic cross-sectional view of a transparent operating element I according to an exemplary embodiment of the invention. It comprises an amorphous transparent body 2 having multiple lateral surfaces arranged at angles in relation to one another, of which only three are visible in the cross-sectional view of FIG. 1. Thus, in FIG. 1 a first lateral surface forms a user-side front side 3 (also called end side) of the body 2, a second lateral surface forms a rear side 4 of the body 2 facing away from the user, while a third lateral surface forms an edge side 5 of the body 2, which connects the front side 3 to the rear side 4 and is not visible to the user in this example. Solely by way of example, these three lateral surfaces are formed planar (i.e. flat), so that the body 2 has a triangular cross-section. The user is only indicated in FIG. 1 by his/her approximate viewing direction B.

A symbol generating device 6 is arranged on the lateral surface which forms the edge side 5 of the body 2 in FIG. 1. It is designed to generate at least one operating symbol luminescent inward into the body 2 in this lateral surface. In this example, the symbol generating device 6 comprises multiple light sources (not shown) for this purpose, for example LEDs, and a mirrored light mask 7 illuminated from the latter, which is formed on one of the mentioned lateral surfaces and has openings (not shown) in the form of these operating symbols. In this example, the light sources are housed in a housing 8, which is fastened on the mentioned lateral surface of the body 2. The evaluation electronics unit mentioned herein is also housed in the same housing 8.

In this case, the rear side 4 of the body 2, which is transparent to the user, is designed and arranged so that it reflects the light L originating from the luminescent operating symbols substantially without loss within the body 2 to its front side 3. At the front side 3, this light L emerges from the body 2 in the direction of the user, due to which each operating symbol appears to him/her as its virtual projection S having a corresponding position P in the front side 3. The front side 3 is made touch-sensitive here by a conductive transparent surface coating 9, so that each projected operating symbol S is operable by touching its position P in the front side 3. Conductor tracks are also formed for this purpose in the conductive coating 9, which lead to the evaluation electronics unit housed in the housing 8, in which the desired functionality of the respective projected operating symbol S is implemented FIG. 2 shows a perspective view of a transparent operating element 1 according to a further exemplary embodiment of the invention from the viewing direction B of its user (cf. FIG. 1). The fundamental design and the function correspond here to those of FIG. 1, so that only additional details, which were not already described with reference to FIG. 1, are described hereinafter to avoid repetitions.

The operating element 1 is designed in this example for attachment as a shifter module to a steering wheel (not shown) of a motor vehicle. The transparent operating element 1 can be fastened here with its edge side 5 on the steering wheel so that the transparent body 2 having its transparent front and rear sides 3, 4 hangs in the air directly in the field of view of its user, in this case a driver, while the housing 8 (in which the symbol generating device 6 and the evaluation electronics are housed, cf. FIG. 1) are concealed in the steering wheel. The above advantages (“magic technology”) of the operating element I thus apply here.

The individual projected operating symbols S form steering wheel buttons in this example, which are operable by touching the front side 3 at the points (positions P. of. FIG. 1), at which the user/driver sees them. Thus, for example, “+” can cause a change to the next higher radio transmitter frequency, “−” can be provided for change to the next lower radio transmitter frequency, “OK” can confirm another input, and much more, as symbolically indicated in FIG. 2.

In FIG. 2, the front side 3 of the body 2 is composed in a faceted manner of multiple planar lateral surfaces arranged at angles in relation to one another. The adjacent lateral surfaces directly adjoin one another here and merge continuously into one another to form a facet edge 10 which is haptically and also visually perceptible to the user. The facet edges 10 contribute to the haptic orientation in the front side 3 during the intended use of the operating element 1. Some of the projected operating symbols S are therefore located in FIG. 2 on different sides of such facet edges 10.

### LIST OF REFERENCE SIGNS

1 transparent operating element
2 amorphous transparent body
3 user-side front side
4 rear side
5 edge side
6 symbol generating device
7 light mask
8 housing
9 conductive transparent surface coating
10 facet edge
L light
B viewing direction
S virtual projected operating symbol or its virtual projection
P its position in the front side

1.-10. (canceled)

11. A transparent operating element, comprising:
an amorphous transparent body having multiple lateral surfaces arranged at angles in relation to one another, each of which individually or in groups form a user-side front side, a rear side facing away from the user, and an edge side of the body connecting the front side to the rear side; and
a symbol generating device, which is arranged on at least one lateral edge-side surface of the body and is configured to generate at least one operating symbol luminescent inward into the body therein;
wherein the rear side is designed to reflect light originating from the at least one operating symbol inside the body to the front side, which is designed to decouple said light out of the body in a direction of the user, so that each operating symbol appears to the user as a virtual projection having a corresponding predetermined position in the front side, and
wherein the front side is transparent and touch-sensitive such that each projected operating symbol is deliberately operable by touching its position in the front side.

12. The operating element according to claim 11, wherein
at least one of multiple lateral surfaces of the body is formed planar.

13. The operating element according to claim 11, wherein
the front side is composed in a faceted manner of multiple lateral surfaces arranged at angles in relation to one another, wherein at least two of the projected operating symbols are located on different sides of at least one facet edge thus formed.

14. The operating element according to claim 11, wherein
the symbol generating device comprises at least one light source and a light mask having openings in the form of the at least one operating symbol, so that the light generated by the at least one light source penetrates through said openings into the interior of the body.

15. The operating element according to claim 11, wherein
the front side is touch sensitive by comprising at least one essentially transparent electrically conductive layer or coating structure depending on location, which comprises conductor tracks formed according to the position of each individual projected operating symbol, which lead to an associated evaluation electronics unit.

16. The operating element according to claim 15, wherein
the evaluation electronics unit is formed on the same at least one lateral edge-side surface on which the symbol generating device is arranged, and/or is provided in a common housing with said symbol generating device.

17. The operating element according to claim 11, wherein
the operating element is a component of a shifter module on a steering wheel or on a steering column of a vehicle.

18. A method for producing an operating element, the method comprising the steps of:
providing an amorphous transparent body having multiple lateral surfaces arranged at angles in relation to one another, each of which, individually or in groups, form a user-side front side, a rear side facing away from the user, and an edge side of the body connecting the front side to the rear side;
forming, arranging, or fastening, on at least one lateral edge-side surface of the body, a symbol generating device configured to generate at least one operating symbol luminescent inward into the body;
wherein the rear side is designed to reflect light originating from the at least one operating symbol inside the body to the front side, which is designed to decouple the light out of the body in a direction of the user, so that the at least one operating symbol appears to the user as a virtual projection at a corresponding predetermined position in the front side; and
forming an essentially transparent touch-sensitive layer or coating in or on the front side of the body, so that each projected operating symbol is deliberately operable by touching its position in the front side.

19. The method according to claim 18, wherein
during the forming of the touch-sensitive coating, the front side of the body is first coated using an electrically conductive material of a constant layer thickness, in the case of which the material remains essentially transparent from the viewpoint of the user; and
subsequently structuring said coating by location-dependent removal of the electrically conductive material to create touch sensitivity.

20. A vehicle, comprising:
a passenger compartment; and
at least one transparent operating element according to claim 11.
